(19) United States
(12) Patent Application Publication
(10) Pub. No.: US 2012/0131536 A1
(43) Pub. Date: May 24, 2012

(54) VERIFICATION APPARATUS FOR SEMICONDUCTOR INTEGRATED CIRCUIT AND VERIFICATION METHOD FOR SEMICONDUCTOR INTEGRATED CIRCUIT

(75) Inventor: Tomoko KITAZAWA, Kanagawa (JP)

(73) Assignee: KABUSHIKI KAISHA TOSHIBA, Tokyo (JP)

(21) Appl. No.: 13/184,460

(22) Filed: Jul. 15, 2011

(30) Foreign Application Priority Data
Nov. 24, 2010 (JP) 2010-261675

(51) Int. Cl. G06F 17/50

(52) U.S. Cl. 716/136

(57) ABSTRACT

A verification apparatus for a semiconductor integrated circuit according to an embodiment includes a setting file storing unit having stored therein a list in which a scenario and a parameter used for verification are described and a transfer data generating unit configured to generate, on the basis of the list, transfer data used for the verification. The transfer data generating unit generates a tag in which information of the scenario is described.

### CROSS-REFERENCE TO RELATED APPLICATION

This application is based upon and claims the benefit of priority from the Japanese Patent Application No. 2010-261675, filed on Nov. 24, 2010; the entire contents of which are incorporated herein by reference.

### FIELD

Embodiments described herein relate generally to a verification apparatus for a semiconductor integrated circuit and a verification method for a semiconductor integrated circuit.

### BACKGROUND

According to a reduction in size and improvement of performance of electronic apparatuses in recent years, there is an increasing need for a multifunction semiconductor integrated circuit (hereinafter referred to as system LSI) in which plural functions required of the electronic apparatuses are integrated in one chip.

In the past, in verification of a system LSI, verification for checking that data transfer is performed as specified in specifications is performed among various IF modules mounted on a verification target system LSI such as a serial IF, a parallel IF, an input and output IF for video and audio, a DMAC, and a memory IF. In this verification, verification with a transmission method (a command and a parameter), a transmission source, a transmission destination, transmission data, and the like changed is conducted by combining different channels of a certain IF module or combining the IF module with another IF module to simulate the operation of the entire system LSI.

Such verification of data transfer is usually performed in a logical simulation using a test program in which a scenario of the data transfer is described. When the test program is executed by a processor incorporated in the system LSI, if a data transfer result does not coincide with an expected value, it is necessary to find a deficient place. Specifically, it is necessary to analyze to which data transfer the scenario described in the test program is correctly executed and which data transfer in which module is not correctly executed.

In this case, a user causes a screen to display, as a waveform, circuit information of the system LSI obtained by performing the logical simulation and visually checks an IF signal of an input and output IF, a signal of a bus, a signal of a memory IF, and the like arranged on a data transfer path to thereby determine whether the data transfer is correctly performed. However, in the test program, usually, the scenario is described such that data transfer on plural different paths is performed or data transfer is performed plural times on the same path. Therefore, extremely long time is required to specify to which data transfer described in the test program a signal of a waveform checked on the screen relates.

Other than the visual check of the screen, in the past, a method is also used in which a change due to an event of a main IF signal on a data transfer path or content of a memory is output to a file and the file is analyzed to check whether data transfer is correctly performed. However, according to improvement of integration of a system LSI and improvement of functions implemented in the system LSI, complexity of data transfer dramatically increases. Therefore, extremely long time is required to analyze the file as well.

### BRIEF DESCRIPTION OF THE DRAWINGS

FIG. 1 is a schematic block diagram for explaining an example of a configuration of a verification apparatus 1 for a semiconductor integrated circuit according to a first embodiment;

FIG. 2 is a schematic block diagram for explaining a detailed configuration of components related to generation of a test program 41 and transfer data 43 according to the first embodiment;

FIG. 3 is a diagram for explaining an example of a scenario list 21 according to the first embodiment;

FIG. 4 is a diagram for explaining an example of a parameter list 22 according to the first embodiment;

FIG. 5 is a diagram for explaining an example of a tag 420 according to the first embodiment;

FIGS. 6A and 6B are diagrams for explaining an example of the transfer data 43 for each processor that is caused to execute a verification scenario according to the first embodiment;

FIG. 7 is a flowchart for explaining a procedure for generating the transfer data 43 according to the first embodiment;

FIG. 8 is a schematic block diagram for explaining an example of a verification target semiconductor integrated circuit 61 according to the first embodiment;

FIG. 9 is a schematic diagram for explaining a display example of a signal of a verification result obtained by a logical simulation in an output unit 3 according to the first embodiment;

FIG. 10 is a diagram for explaining an example of transfer data in which a specific pattern is used in a specific bit position according to the first embodiment;

FIG. 11 is a diagram for explaining an example of transfer data 43b′ incorporating a tag in a specific bit position according to the first embodiment;

FIG. 12 is a diagram for explaining generation of a tag 426h according to a second embodiment; and

FIGS. 13A and 13B are diagrams for explaining an example of transfer data in which a fixed-length tag according to the second embodiment is used.

### DETAILED DESCRIPTION

A verification apparatus for a semiconductor integrated circuit according to an embodiment includes a setting file storing unit having stored therein a list in which a scenario and a parameter used for verification are described and a transfer data generating unit configured to generate, on the basis of the list, transfer data used for the verification. The transfer data generating unit generates a tag in which information of the scenario is described.

Embodiments are explained below with reference to the accompanying drawings.

### First Embodiment

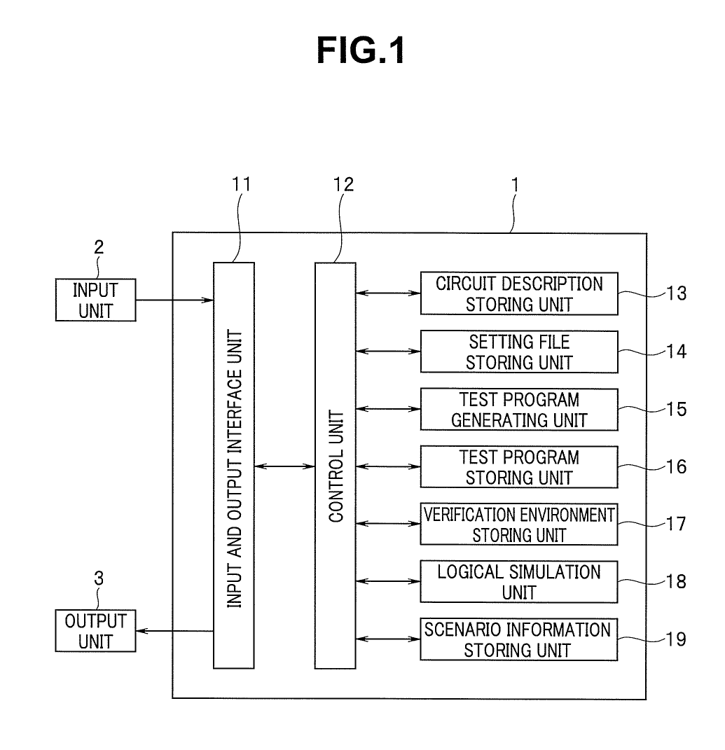

First, a configuration of a verification apparatus 1 for a semiconductor integrated circuit according to a first embodiment of the present invention is explained with reference to FIG. 1. FIG. 1 is a schematic block diagram for explaining an example of the configuration of the verification apparatus 1 for a semiconductor integrated circuit according to the first embodiment of the present invention.

As shown in FIG. 1, the verification apparatus 1 for a semiconductor integrated circuit (hereinafter referred to as verification apparatus 1) according to the first embodiment of the present invention is connected to an input unit 2 configured to input various kinds of information such as a setting value concerning verification and an output unit 3 configured to output a verification result. Specifically, the input unit 2 is, for example, a keyboard or a mouse and the output unit 3 is, for example, a screen such as a CRT or a storage device configured to store data.

The verification apparatus 1 includes an input and output interface unit 11 connected to the input unit 2 and the output unit 3 and a control unit 12 configured to control operations of units included in the verification apparatus 1. The verification apparatus 1 includes a circuit description storing unit 13 having stored therein design data of a verification target semiconductor integrated circuit, a setting file storing unit (or module) 14 having stored therein various kinds of setting information concerning verification, a test program generating unit 15 configured to generate a test program 41 and the like used for verification, and a test program storing unit 16 configured to store the generated test program 41.

The verification apparatus 1 further includes a verification environment storing unit 17 having stored therein a verification environment, a logical simulation unit 18 configured to execute a logical simulation according to the test program 41, and a scenario information storing unit (or module) 19 having stored therein a default verification scenario and the like.

The respective components are explained in detail below.

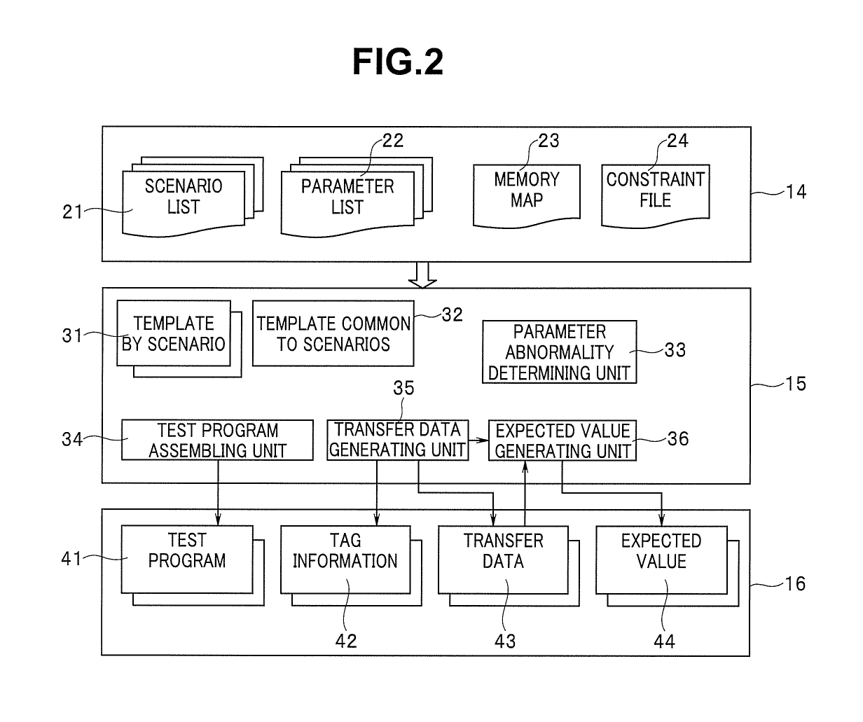

In the setting file storing unit 14, as shown in FIG. 2, a scenario list 21, a parameter list 22, a memory map 23, and a constraint file 24 are stored. FIG. 2 is a schematic block diagram for explaining a detailed configuration of components related to generation of the test program 41 and transfer data 43.

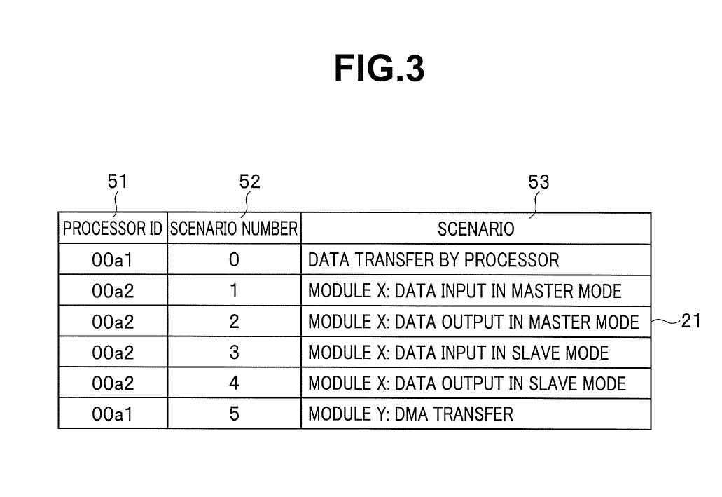

The scenario list 21 is a list in which a scenario executed in verification is set. For example, contents shown in FIG. 3 are described in the scenario list 21. FIG. 3 is a diagram for explaining an example of the scenario list 21. As shown in FIG. 3, plural scenarios are stored in the scenario list 21 as a list. For each of the scenarios, a processor ID 51 for identifying a processor caused to execute the scenario as a command, a scenario number 52 for uniquely identifying the scenario, and a specific scenario 53 to be verified are set. In other words, in each of the scenarios, information concerning three items of the processor ID 51, the scenario number 52, and the scenario 53 is set.

In the example shown in FIG. 3, six scenarios having scenario numbers 52 “0” to “5” are set in the scenario list 21. For example, in the scenario having the scenario number 52 “0”, a scenario is set to cause a processor defined by the processor ID 51 “00a1” to execute data transfer.

When only one processor is incorporated in a verification target semiconductor integrated circuit, since the same value is set in the processor ID 51 for all the scenarios, this item may be omitted from the scenario list 21. When processors include plural cores, the processor ID 51 is set such that a processor and a core caused to execute a scenario can be specified. The scenario 53 may be subdivided and itemized as two or more items. For example, the scenario 53 may be divided and itemized as a transfer module and a function to be executed. When the scenario 53 is itemized in this way, for example, in a scenario having the scenario number “1”, “module X” is set as the transfer module and “data input in a master mode” is set as the function to be executed.

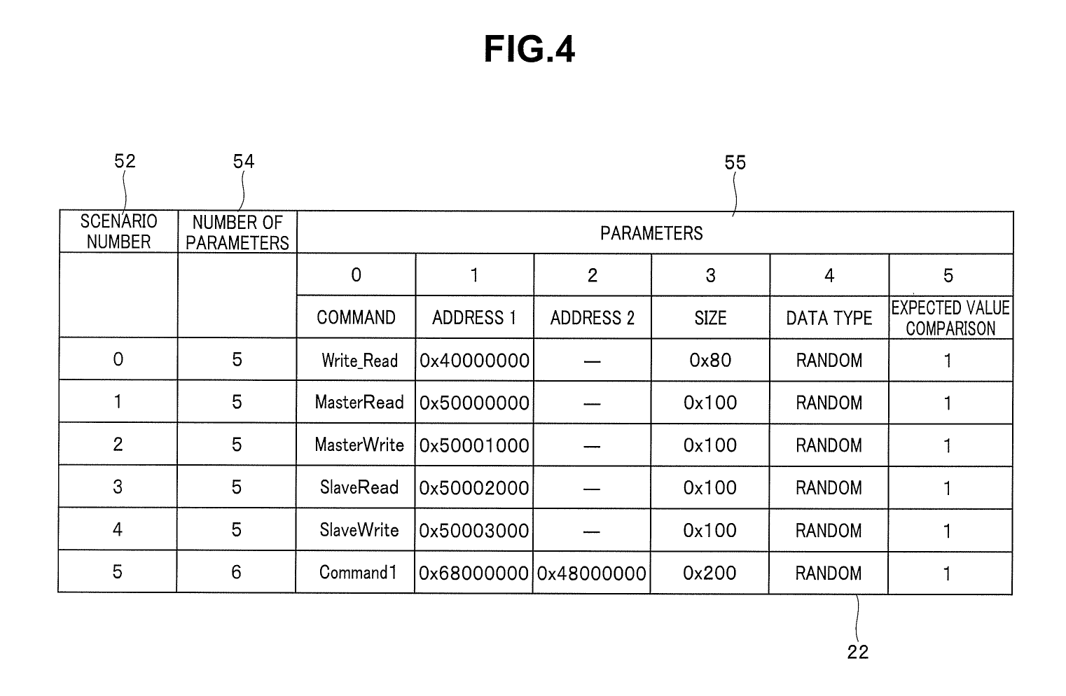

The parameter list 22 is a list in which detailed parameters used in a scenario executed in verification are set. For example, contents shown in FIG. 4 are described in the parameter list 22. FIG. 4 is a diagram for explaining an example of the parameter list 22. As shown in FIG. 4, in the parameter list 22, a scenario number 52 for identifying for which of the scenarios described in the scenario list 21 the parameters are used, a number of parameters 54 indicating the number of parameters used in a scenario, and parameters 55 that are specific setting values, are described.

In the parameters 55, items of parameters used in a scenario are listed. In the example shown in FIG. 4, the parameter list 22 is configured such that six items can be set as the parameters 55. Specifically, “command” indicating a function to be executed is set as a parameter 0 and “address 1” and “address 2” indicating addresses of data access destinations are set as a parameter 1 and a parameter 2. “Size” indicating size of transfer data is set as a parameter 3, “data type” indicating a method of generating transfer data is set as a parameter 4, and “expected value comparison” indicating whether output data after transfer (output data obtained when a scenario is executed) and an expected value are compared is set as a parameter 5.

As the “data type” of the parameter 4, besides “random” indicating transfer data is generated at random, “fixed” indicating that a specific fixed value is used or the like is set. In the “expected value comparison” of the parameter 5, “1” is set when the output data after transfer and the expected value are compared. “0” is set when the output data after transfer and the expected value are not compared.

The parameter list 22 is a list in which detailed parameters concerning the respective scenarios described in the scenario list 21 are described. Therefore, it is not always necessary to divide the parameter list 22 and the scenario list 21 as lists. Both the lists may be consolidated as one list and stored in the setting file storing unit 14. However, if the parameter list 22 and the scenario list 21 are separately prepared, when a part of parameters are changed and verification is performed in the same scenario (e.g., under the same conditions except the part of parameters, verification is performed in both the cases in which the output data and the expected value are compared and in which the output data and the expected value are not compared), the parameter list 22 only has to be changed or a new record only has to be added without updating the scenario list 21. Therefore, there is an advantage that the change is easy and maintainability of data is improved.

When the verification target semiconductor integrated circuit includes plural processors, the scenario list 21 may be created for each of the processors.

The memory map 23 is a file in which an address of a main memory and an address of a sub memory are defined. The addresses are determined by specification of the verification target semiconductor integrated circuit, i.e., design data of the circuit description storing unit 13. When the semiconductor integrated circuit includes plural processors, as in the scenario list 21 or the like, the memory map 23 may be created for each of the processors and plural maps may be stored in the setting file storing unit 14.

The constraint file 24 is a file in which constraints in generating a test program are described. In this file, for example, a memory space to which access is prohibited is described.

The test program generating unit 15 includes, as shown in FIG. 2, a parameter abnormality determining unit 33, a test program assembling unit (or module) 34, a transfer data generating unit (or module) 35, and an expected value generating unit (or module) 36. In the test program generating unit 15, a template by scenario 31 and a template common to scenarios 32 are stored as information necessary for generating the test program 41.

The template by scenario 31 is a file of a template corresponding to a scenario used for verification. For example, when the test program 41 is described in a C language, a DEFINE statement and a program as a sample obtained by embodying a scenario are described in the template by scenario 31. The template common to scenarios 32 is a file in which program information common to all verification scenarios is defined. For example, a so-called boot code for specifying an initial operation of a processor and libraries read out from template by scenarios 31 are described.

The parameter abnormality determining unit 33 determines, referring to the memory map 23 and the constraint file 24, whether an abnormal situation in which a prohibited address or an absent address is accessed occurs when the test program 41 is created and executed using parameters set in the selected parameter list 22.

The test program assembling unit 34 assembles the test program 41 used for verification on the basis of information input from the input unit 2 and the setting file storing unit 14, the template by scenario 31, and the template common to scenarios 32. Specifically, the test program assembling unit 34 selects a relevant template from the template by scenario 31 referring to the scenario list 21 selected according to an instruction from the input unit 2 and generates a provisional program. The template by scenario 31 selected for one scenario list 21 is not limited to one. In some case, plural templates are selected. Subsequently, the test program assembling unit 34 sets parameters set in the selected parameter list 22 in a predetermined place of the provisional program and adds a program described in the template common to scenarios 32 to assemble the test program 41.

The transfer data generating unit 35 generates the transfer data 43 used for verification on the basis of information input from the input unit 2 and the setting file storing unit 14. Specifically, first, the transfer data generating unit 35 generates basic data for transfer referring to “size” and “data type” of the parameters 55 set in the selected parameter list 22. For example, when the parameter list 22 shown in FIG. 4 is selected, since the “size” of the parameter 55 of a list having the scenario number 52 “0” is “0×80” and the “data type” of the parameter 55 is “random”, the transfer data generating unit 35 generates, as basic data for transfer, data having data length 0×80 and a random value.

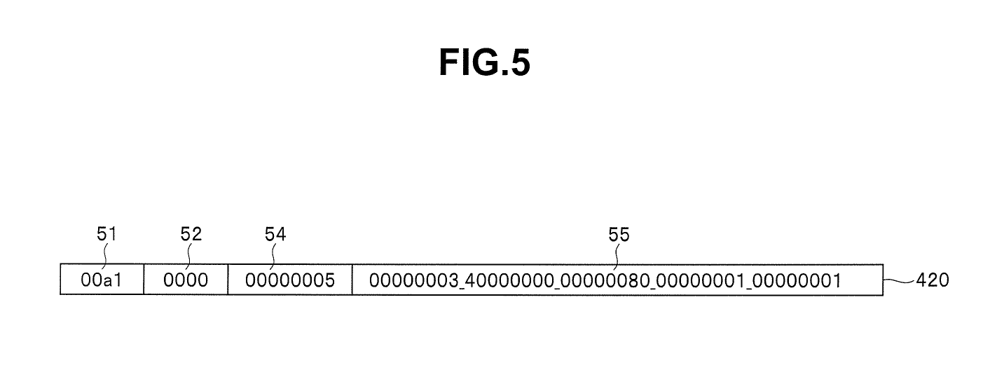

Subsequently, the transfer data generating unit 35 refers to an instruction concerning whether a tag is incorporated in the transfer data 43 and, when a tag is incorporated, generates a tag 420 shown in FIG. 5. FIG. 5 is a diagram for explaining an example of the tag 420. The tag 420 is data in which the selected processor ID 51, the scenario number 52, the number of parameters 54, and values of the parameters 55 converted into numerical values are arranged in order.

For example, in the case of a scenario having the scenario number 52 “0”, with reference to a relevant list of the scenario list 21 shown in FIG. 3, “00a1” is extracted as a processor ID and, with reference to a relevant list of the parameter list 22 shown in FIG. 4, “5” is extracted as the number of parameters 54. As the parameters 55, “Write_Read” of the “command”, “0×40000000” of the “address 1”, “0×80” of the “size”, “random” of the “data type”, and “1” of the “expected value comparison” are extracted. Each of these individual parameters are digitized to have length of 4 bytes, for example, “Write_Read” is digitized as 00000003, “0×40000000” is digitized as 40000000, “0×80” is digitized as 00000080, “random” is digitized as 00000001, and “1” is digitized as 00000001.

Further, the selected processor ID 51 and the scenario number 52 are adjusted to length of 2 bytes and the number of parameters 54 is adjusted to length of 4 bytes. The digitized parameters 55 are arranged following the processor ID 51, the scenario number 52, and the number of parameters 54 to generate the tag 420 having length of 28 bytes shown in FIG. 5.

The lengths of the elements included in the tag 420 are not limited to the values described above and can be determined taking into account upper limits of the number of processors of the verification target semiconductor integrated circuit, the number of scenarios to be verified, and the number of parameters, visibility in the case in which a verification result is visually observed, and the like. For example, in FIG. 5, the length of the number of parameters 54 is 4 bytes. However, the length may be 1 byte or 2 bytes.

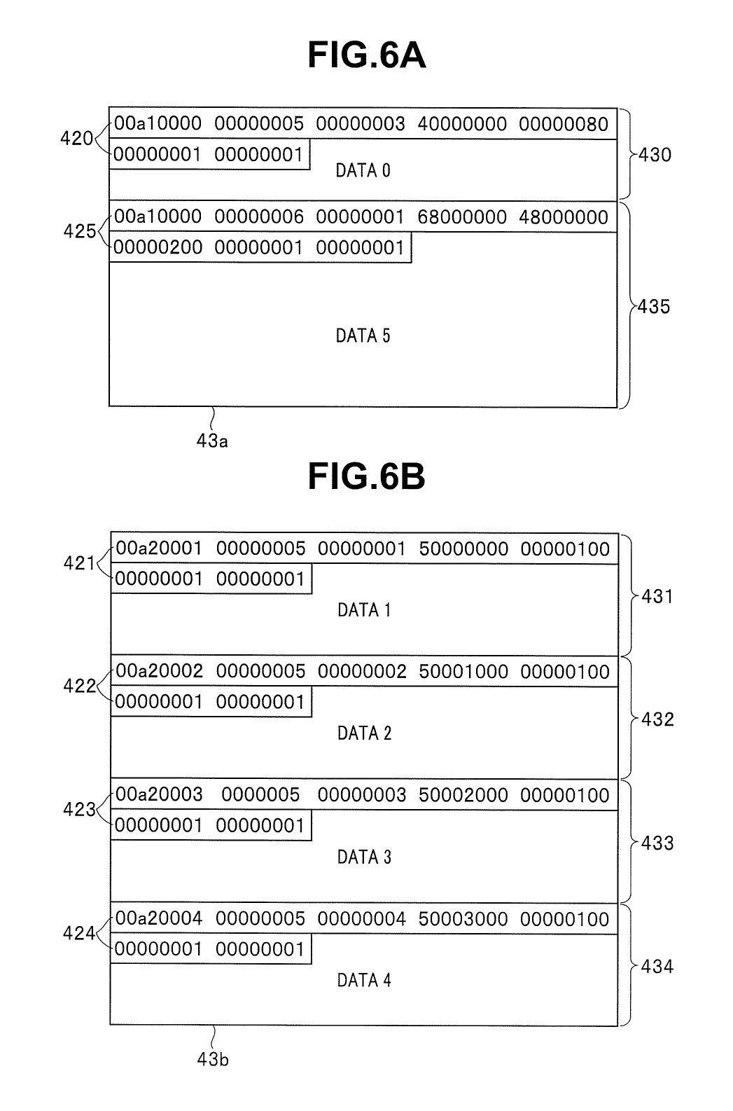

The generated tag 420 is replaced with data of a relevant place of the basic data for transfer on the basis of a tag incorporating start position and the length of a tag instructed from the input unit 2 or the like and the transfer data 43 is generated and output to a file. An example of the transfer data 43 is shown in FIGS. 6A and 6B. FIGS. 6A and 6B show the transfer data 43 for each processor that is caused to execute a verification scenario. FIG. 6A shows transfer data 43a for a processor defined by a processor ID “00a1”. FIG. 6B shows transfer data 43b for a processor defined by a processor ID “00a2”.

FIGS. 6A and 6B show the transfer data 43 in the case in which an instruction is input to incorporate a tag having length of 28 bytes in the top of transfer data and a scenario is executed using the scenario list 21 shown in FIG. 3 and the parameter list 22 shown in FIG. 4. Concerning the scenario having the scenario number 52 “0”, as explained above, the tag 420 shown in FIG. 5 is generated, the tag 420 is replaced with data in a place equivalent to 28 bytes from the top of basic data for transfer 0, and a transfer data 430 is generated.

Concerning the five scenarios having the scenario numbers 52 “1” to “5”, similarly, tags 421, 422, 423, 424, and 425 are respectively generated, the tags 421, 422, 423, 424, and 425 are replaced with data of places equivalent to 28 bytes from the tops of basic data for transfer 1, 2, 3, 4, and 5, and transfer data 431, 432, 433, 434, and 435 are respectively generated. When output data obtained by execution of a scenario and an expected value are compared, the generated transfer data 43 is output to the expected value generating unit 36 as well.

The generated tags 420 to 425 are filed as the tag information 42 and output to the test program storing unit 16. In other words, the tag information 42 is a list of tags 420 to 425 finally incorporated in the transfer data 43. The tag information 42 is used when a tag is specified from waveform display of a signal on which the transfer data 43 is carried or from a signal output to and displayed on the output unit 3.

In this way, if the top 2 bytes and the next 2 bytes of the tags 420 to 425 arranged at the tops of the transfer data 430 to 435 are referred to, it is immediately seen data of which verification scenario executed in which processor the respective transfer data 430 to 435 are. Therefore, it is easy to analyze the data.

The instructions for the tag incorporating start position and the length of the tag may be set by adding an item in the parameter list 22 or may be set in advance in another file instead of being input from the input unit 2.

The expected value generating unit 36 generates an execution result of an expected scenario (=an expected value 44) on the basis of the input transfer data 43 and outputs the execution result to a file.

In the test program storing unit 16, as shown in FIG. 2, the various files generated by the test program generating unit 15, specifically, the test program 41, the tag information 42, the transfer data 43, and the expected value 44 generated by the expected value generating unit 36 are stored.

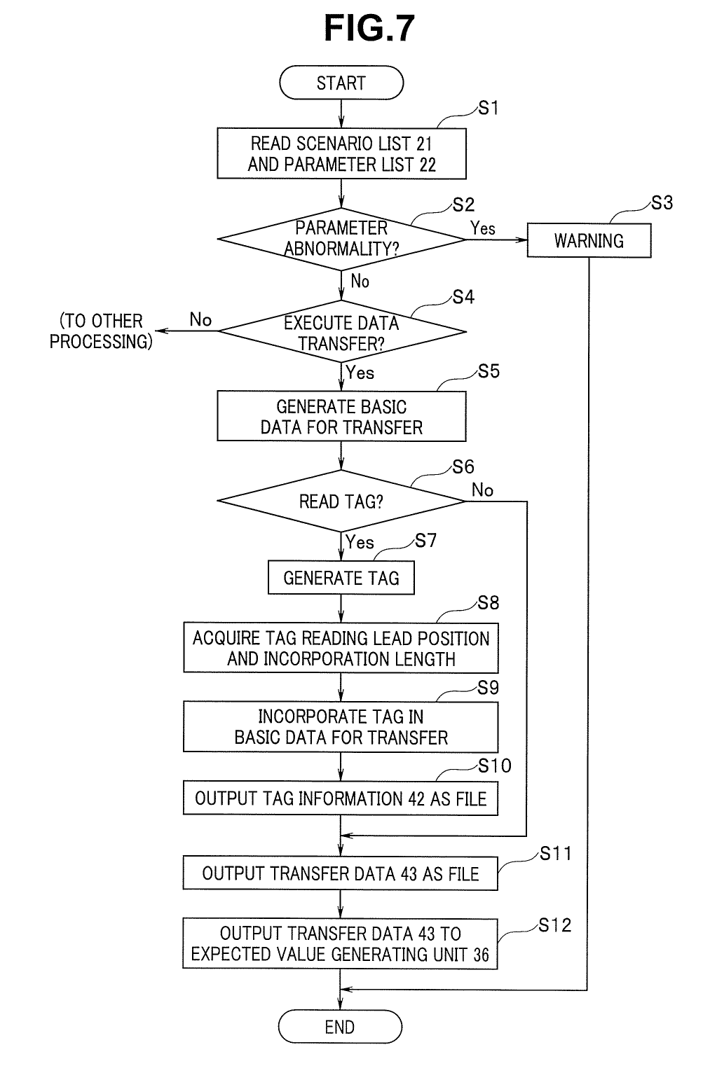

A specific procedure for generating the transfer data 43, which is the point of this embodiment, is explained with reference to FIG. 7. FIG. 7 is a flowchart for explaining the procedure for generating the transfer data 43.

As shown in FIG. 7, first, in step S1, the verification apparatus 1 selects the scenario list 21 and the parameter list 22 used for verification out of plural scenario lists 21 and plural parameter lists 22 stored in the setting file storing unit 14 and outputs the scenario list 21 and the parameter list 22 to the test program generating unit 15. The scenario list 21 and the parameter list 22 used for verification and setting of detailed verification conditions (whether to incorporate a tag, a tag incorporation start position and length of a tag, whether to compare with an expected value, etc.) may be directly instructed from the input unit 2 when verification is performed or may be set as default information in the scenario information storing unit 19.

Subsequently, the verification apparatus 1 proceeds to step S2. The verification apparatus 1 checks parameters set in the selected parameter list 22 against the constraint file 24, the memory map 23, and the like. The verification apparatus 1 determines, in the parameter abnormality determining unit 33, whether there is an abnormal value in the parameters. When it is determined that a parameter is abnormal, the verification apparatus 1 proceeds to step S3. The verification apparatus 1 displays a warning on the output unit 3 and ends the generation of the transfer data 43.

On the other hand, when it is determined in step S2 that there is no abnormality in the parameters, the verification apparatus 1 proceeds to step S4 and determines whether data transfer is included in a verification scenario. When the data transfer is not included, the verification apparatus 1 ends the generation of the transfer data 43 and shifts to execution of a logical simulation based on the assembled test program 41.

On the other hand, when it is determined in step S4 that data transfer is included in the verification scenario, the verification apparatus 1 proceeds to step S5 and generates basic data for transfer in the transfer data generating unit 35. The basic data for transfer is generated according to an instruction input from the input unit 2, information of the scenario information storing unit 19, and the like with reference to “size” and “data type” of the parameters set in the parameter list 22 selected in step S1.

Subsequently, the verification apparatus 1 proceeds to step S6 and determines whether a tag is to be incorporated in the transfer data 43. Whether to incorporate a tag is input from the input unit 2 or set in the scenario information storing unit 19 as default information. If it is determined that a tag is not to be incorporated, the verification apparatus 1 sets the basic data for transfer generated in step S5 as the transfer data 43 and proceeds to step S11.

On the other hand, when it is determined in step S6 that a tag is to be incorporated in the transfer data 43, the verification apparatus 1 proceeds to step S7 and generates a tag in the transfer data generating unit 35. The tag is data in which the selected processor ID 51, the scenario number 52, the number of parameters 54, and values of the parameters 55 converted into numerical values are arranged in order. A method of generating the tag is as explained above.

Subsequently, in step S8, the verification apparatus 1 acquires a position where the tag is incorporated and length for incorporating the tag. Like the presence or absence of incorporation of a tag, the tag incorporating position and the tag incorporating length are input from the input unit 2 or set in the scenario information storing unit 19 as default information.

Subsequently, the verification apparatus 1 proceeds to step S9, incorporates the tag generated in step S7 in the basic data for transfer generated in step S5, and generates the transfer data 43. The tag incorporating position and length conform to the position and the length acquired in step S8. Further, in step S10, the verification apparatus 1 makes the tag generated in step S7 into a file as the tag information 42 and outputs the tag information 42 to the test program storing unit 16.

Subsequently, in step S11, the verification apparatus 1 makes the generated transfer data 43 into a file and outputs the transfer data 43 to the test program storing unit 16. Finally, in step S12, the verification apparatus 1 outputs the transfer data 43 to the expected value generating unit 36 and ends the generation of the transfer data 43.

In this way, when the transfer data 43 is generated, whether a tag is to be incorporated in the transfer data 43 is selectable. Therefore, it is possible to save labor and time for tag generation concerning verification for which a tag is unnecessary and reduce generation time for data. In a normal test, the test program 41 is executed using data not incorporating a tag (the basic data for transfer) as the transfer data 43. When a result is different from the expected value 44, the transfer data 43 incorporating a tag is generated and the same test program 41 is executed to specify a deficient place. In this way, it is possible to generate the transfer data 43 according to a purpose of verification.

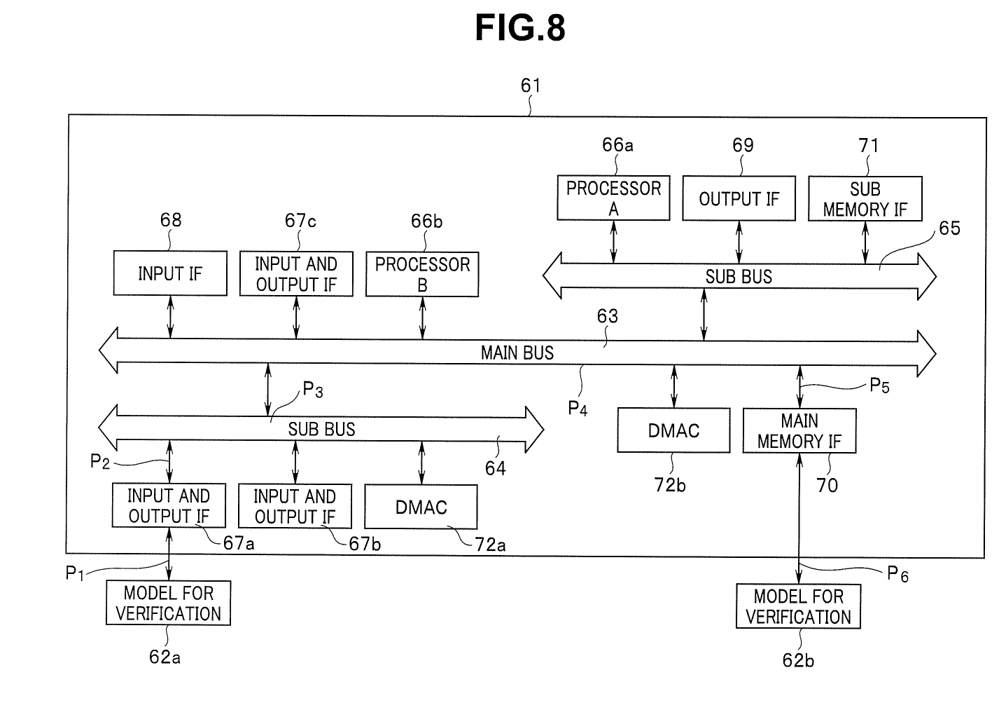

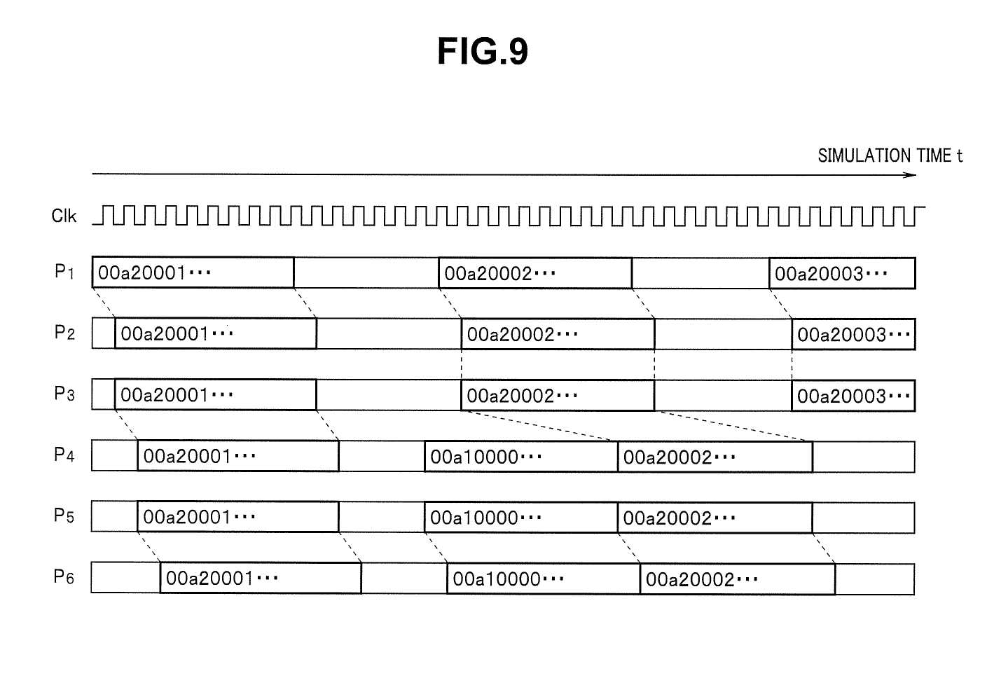

A signal displayed on the output unit 3 when verification of data transfer is performed using the verification apparatus 1 according to this embodiment is schematically explained using FIGS. 8 and 9. FIG. 8 is a schematic block diagram for explaining an example of the verification target semiconductor integrated circuit 61. FIG. 9 is a schematic diagram for explaining a display example of a signal of a verification result obtained by a logical simulation in the output unit 3.

In the following explanation, verification of data transfer is performed concerning the multifunction semiconductor integrated circuit 61 including a main bus 63 and two sub buses 64 and 65 connected to the main bus 63 as shown in FIG. 8. An input and output IF 67c, an input IF 68, a processor B 66b, a DMAC 72b, and a main memory IF 70 are connected to the main bus 63. Input and output IFs 67a and 67b and a DMAC 72a are connected to the sub bus 64. A processor A 66a, an output IF 69, and a sub memory IF 71 are connected to the sub bus 65.

For example, models for verification 62a and 62b are respectively connected to the input and output IF 67a and the main memory IF 70. Verification for causing the processor B 66b to execute a command and transferring data from the model for verification 62a to the model for verification 62b through the input and output IF 67a, the sub bus 64, the main bus 63, and the main memory IF 70 (verification using a scenario A) is performed. In this case, a signal on an IN side (P1) and a signal on an OUT side (P2) of the input and output IF 67a, a signal of the sub bus 64 (P3), a signal of the main bus 63 (P4), a signal on an IN side (P5) and a signal on an OUT side (P6) of the main memory IF 70 are displayed as waveforms to perform operation check.

At this point, data transfer on the path is repeatedly performed at a fixed time interval. Verification for causing the processor A 66a to execute a command and to transfer data from the processor A 66a to the model for verification 62b through the sub bus 65, the main bus 63, and the main memory IF 70 (verification using a scenario B) is performed as well. In this case, a data signal having plural bit widths that is a part of a signal of a verification result obtained by the logical simulation is displayed, for example, as shown in FIG. 9. FIG. 9 is a diagram abstractly showing elapse of time of a data signal waveform at points P1 to P6. Rectangles surrounded by thick lines indicate effective data signal portions.

When random data without a tag is used as the transfer data 43, in all data signals appearing as outputs from the verification results P1 to P6 obtained by the logical simulation, random values are displayed. Therefore, when attention is paid to one data signal at a specific point, in particular, when the point is located in a path of transfer data by execution of plural processors, it is difficult to specify as a result of which scenario the signal is obtained, specifically, whether the signal is a verification result of the scenario A or a verification result of the scenario B and, if the signal is the verification result of the scenario A, to specify how many times the data transfer is performed to obtain the verification result.

Therefore, in the past, not only a data signal but also plural signals such as a command signal, an address signal, and a response signal to a command are checked in order according to a scenario to comprehensively check operation. As a result, verification takes time. Since protocols of data transfer are different between P1 and P2 and between P5 and P6, signals to be checked are also different. Since signal waveforms are checked with a thorough knowledge of the protocols, verification takes time.

On the other hand, with the verification apparatus 1 according to this embodiment, verification can be executed by incorporating the processor ID 51, with which a processor that executes a command can be specified, and a tag, with which the scenario number 52 can be identified, in the transfer data 43. For example, the processor ID 51 for identifying the processor A 66a is represented as “00a1” and the processor ID 51 for identifying the processor B 66b is represented as “00a2”. Verification is performed using the transfer data 43 incorporating at the top of the data a tag in which the processor ID 51 is digitized as the top 2 bytes and the scenario number 52 is digitized as the next 2 bytes. This case is considered below.

In this case, as shown in FIG. 9, the tag appears at the top of a signal to which transfer data is output. Therefore, by comparing 4 bytes at the top of the data signal and the tag information 42, it is quite obvious the data signal is a result of data transfer of which scenario or a result of data transfer executed how many times by which processor. For example, the top 4 bytes of a third signal appearing in P4 is “00a20002”. Therefore, it can be easily identified that the data transfer is the result of data transfer having a scenario number “2” executed by the processor B 66b.

Further, when signals of modules of a data transfer path desired to be observed are arranged as shown in FIG. 9, it is possible to quickly visually check propagation of data via the Ifs and the buses according to the arrangement of tags on a data signal.

In this way, in the verification apparatus 1 for a semiconductor integrated circuit according to this embodiment, it is possible to perform verification by incorporating a tag in which information for identifying a processor caused to execute a verification scenario or a command is described in a predetermined position of the transfer data 43 used for verification. Therefore, it is possible to easily specify, using only a data signal, a signal at which time of a data signal is a signal corresponding to data transfer based on which scenario. As a result, it is possible to reduce verification time for data transfer.

In the verification apparatus 1 for a semiconductor integrated circuit according to this embodiment, a tag and tag information are systematically generated when a test program, transfer data, and an expected value are generated. Therefore, it is possible to prevent an error that occurs when a verifier freely gives a tag. A change or addition of a tag due to a change or addition of a scenario or parameters can be automatically performed.

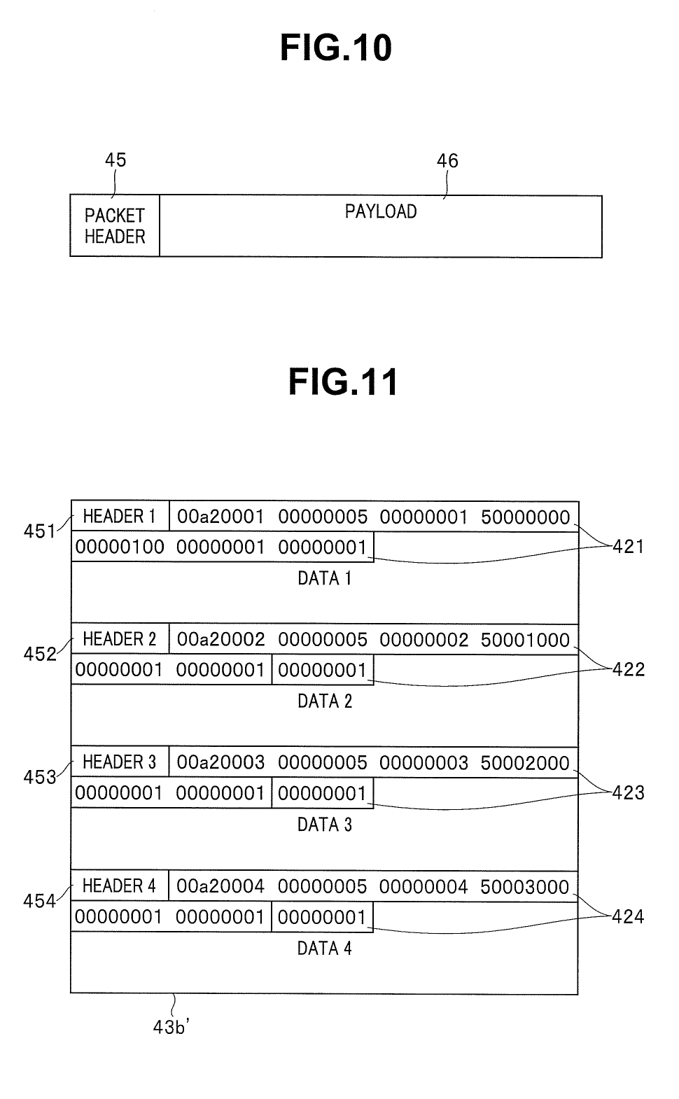

In some case, a module in which it is specified by specifications to use a specific pattern in a specific bit position of the transfer data 43 is included in a verification target semiconductor integrated circuit (see FIG. 10). FIG. 10 is a diagram for explaining an example of transfer data in which a specific pattern is used in a specific bit position. As shown in FIG. 10, in an IF module that receives input of a transport stream in which a payload 46 as a data body follows after a packet header 45, it is specified by specifications that 4 bytes from the top are received as a packet header.

In such a case, as shown in FIG. 11, the tags 421 to 424 are incorporated after packet headers 451 to 454 rather than at the top of transfer data. FIG. 11 is a diagram for explaining an example of transfer data 43b′ incorporating a tag in a specific bit position. FIG. 11 shows the transfer data 43b′ in the case in which the incorporating positions of the tags 421 to 424 of the transfer data 43b shown in FIG. 6B are respectively shifted behind the packet headers 451 to 454.

As explained above, in the verification apparatus 1 for a semiconductor integrated circuit according to this embodiment, an incorporating position of a tag can be freely set and it can be freely set whether a tag is incorporated in the transfer data 43. Therefore, it is possible to further reduce verification time by, for example, executing a portion concerning data transfer of the test program 41 and checking operation using the transfer data 43 incorporating a tag, subsequently transferring data using image data not incorporating a tag, and thereafter continuously performing video decode processing.

When a data amount of the transfer data 43 is smaller than a size of a tag or when a tag is long because the number of parameters 54 is large, length of the tag may be reduced by excluding a part of items included in the tag. In this case, it is advisable to exclude parameters having the same values irrespective of the scenario number 52. For example, in the parameter list 22 shown in FIG. 4, the “data type” and the “expected value comparison” of the parameter 55 always have the same values irrespective of the scenario number 52. Therefore, these parameters can be excluded from a tag when the tag is generated. It is possible to reduce the length of the tag from 28 bytes to 20 bytes by excluding the “data type” and the “expected value comparison” from the tag.

### Second Embodiment

In the embodiment explained above, the length of the tag depends on the number of parameters 54. For example, as shown in FIGS. 6A and 6B, length of the tag 425 concerning a scenario having a large number of items of the parameters 55, i.e., a scenario having the scenario number 52 “5” having the number of parameters 54 “6” is generated longer by 4 bytes than the tags 420 to 424 concerning other scenarios having the number of parameters 54 “5”. On the other hand, a verification apparatus for a semiconductor integrated circuit according to a second embodiment is different from the first embodiment in that length of a tag is fixed irrespective of the number of items of the parameters 55.

In the verification apparatus according to this embodiment, a configuration and a transfer data generation procedure except for the tag information 42 generated in the transfer data generating unit 35 are the same as those in the first embodiment explained with reference to FIGS. 1 to 11. Therefore, explanation of the configuration and the transfer data generation procedure is omitted.

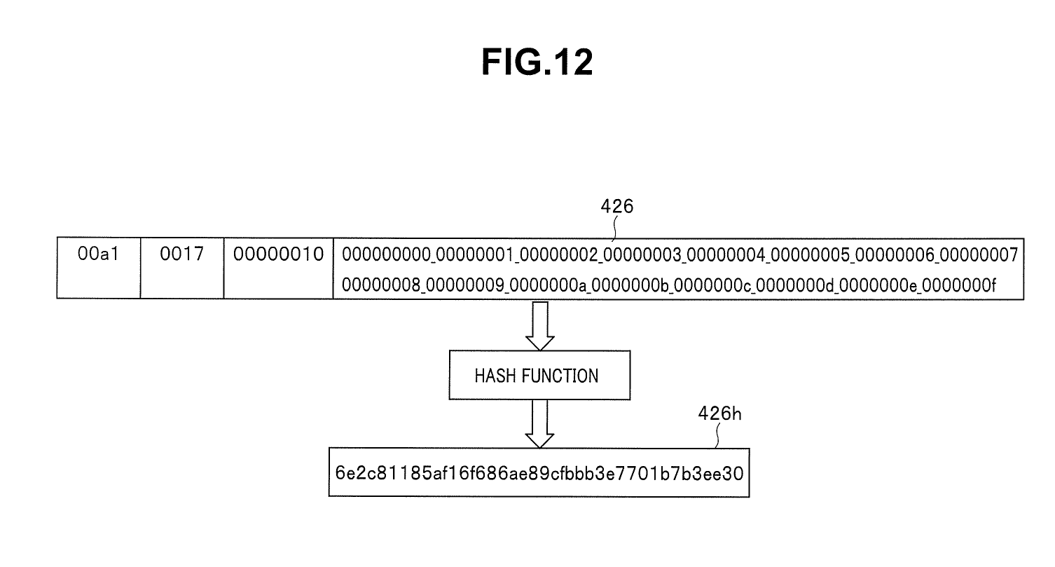

In the first embodiment, the transfer data generating unit 35 generates, as a tag, a value in which the selected processor ID 51, the scenario number 52, the number of parameters 54, and the values of the parameters 55 converted into numerical values described in the scenario list 21 and the parameter list 22 are arranged in order. In this embodiment, the value generated in this way is compressed using a function for obtaining an output having fixed length with respect to an input having arbitrary length to generate a tag. As such a function, for example, a hash function can be used (see FIG. 12).

FIG. 12 is a diagram for explaining generation of a tag 426h in the second embodiment of the present invention. In an example shown in FIG. 12, the tag 426 having the number of parameters 54 “16” and length of 72 bytes is converted into the tag 426h having length of 20 bytes using a hash function SHA-1. The hash function SHA-1 can be easily calculated using a command sha1 sum on Linux. Therefore, it is possible to perform encoding and compression of a tag at low cost.

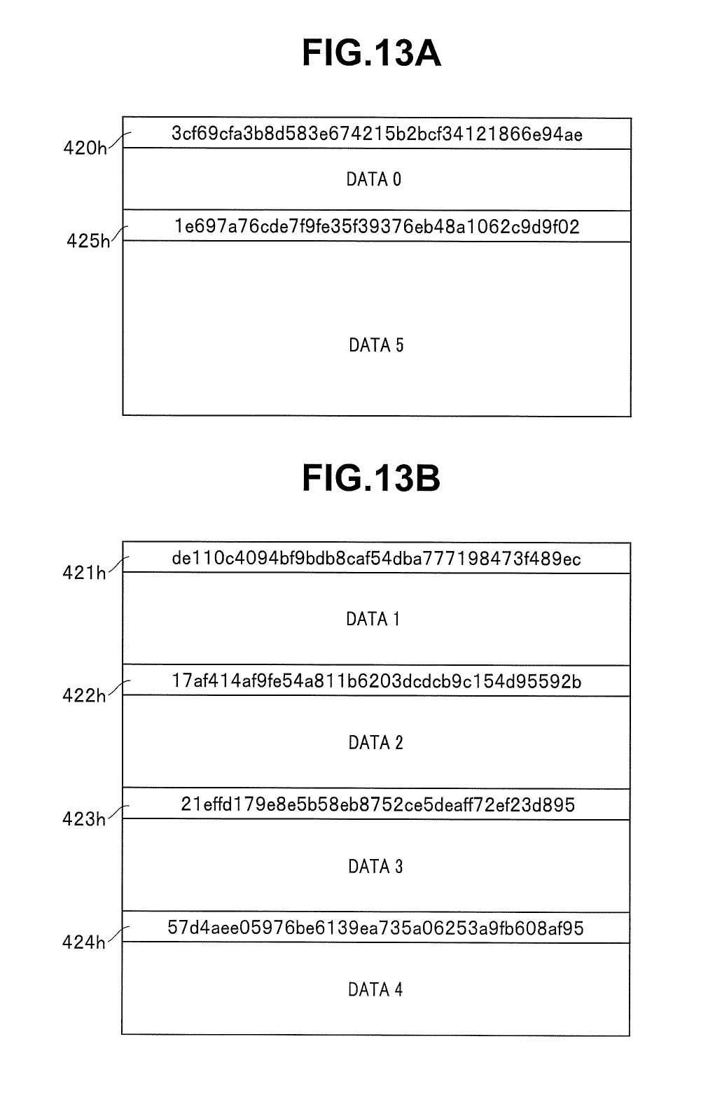

When a tag is converted using such a hash function, for example, the tags 420 to 425 shown in FIGS. 6A and 6B are converted into tags 420h to 425h shown in FIGS. 13A and 13B. All the tags have a fixed length of 20 bytes. FIGS. 13A and 13B are diagrams for explaining an example of transfer data using tags having fixed length.

In this way, in this embodiment, information of a tag is encoded and compressed to be converted into a fixed length. Therefore, it is possible to reduce time required for searching a tag from a data signal displayed as a waveform and reduce verification time for data transfer.

In the example explained above, the hash function SHA-1 is used for compression of a tag. However, a method of compression is not limited to this. Various methods can be applied.

The verification apparatus according to this embodiment can be used not only when a semiconductor device is verified by a logical simulation but also when the semiconductor device is verified by an emulation.

For example, a data signal on which transfer data incorporating a tag is not limited to being directly displayed on the output unit 3. A mechanism for more easily visually identifying the data signal by displaying same tags in same colors at points of a transfer path or, when a specific tag (e.g., a tag for identifying only a specific processor) is designated, displaying a data signal including the designated tag while changing a color of the data signal may be provided in the output unit 3. (A mechanism for highlighting a specific data signal and easily visually identifying the data signal by not only displaying the tags while simply changing the tags to a specific color but also displaying the tags while reversing a color of the tags and a background color or blinking the tags on and off may be provided.)

The information of the signal obtained by the logical simulation is not only displayed as a waveform on a screen. An output form can be freely changed according to a purpose of verification, a need of a user, or the like. For example, a result of comparison of the information and the tag information 42 is made into a file and output.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. A verification apparatus for a semiconductor integrated circuit comprising:
a setting file storage module having stored therein a list describing a scenario and a parameter used for verification of the semiconductor integrated circuit; and
a transfer data generation module configured to generate, based on the list, a tag describing transfer data used for verification and information about the scenario.

2. The verification apparatus for a semiconductor integrated circuit of claim 1, wherein the apparatus is further configured to selectively allow incorporation of the tag in the transfer data.

3. The verification apparatus for a semiconductor integrated circuit of claim 2, wherein the apparatus is further configured to specify a position of the tag in the transfer data.

4. The verification apparatus for a semiconductor integrated circuit of claim 3, wherein
the verification apparatus is configured to verify a multifunction semiconductor integrated circuit comprising a plurality of processors, and
wherein the tag comprises at least one identifier indicative of the processor executing the scenario and also indicative of the scenario.

5. The verification apparatus for a semiconductor integrated circuit of claim 1, wherein the tag is converted into a fixed length.

6. The verification apparatus for a semiconductor integrated circuit of claim 5, wherein the tag is converted into the fixed length using a hash function.

7. The verification apparatus for a semiconductor integrated circuit of claim 1, further comprising an expected value generation module configured to generate an expected value of data generated by a test program based on the list, when the test program is executed using the transfer data.

8. The verification apparatus for a semiconductor integrated circuit of claim 1, wherein
the verification apparatus is further configured to verify a multifunction semiconductor integrated circuit comprising a plurality of processors, and
wherein the tag comprises at least one identifier indicative of the processor configured to execute the scenario and also indicative of the scenario.

9. The verification apparatus for a semiconductor integrated circuit of claim 8, further comprising an expected value generation module configured to generate an expected value of data generated by a test program based on the list, when the test program is executed using the transfer data.

10. A verification method for a semiconductor integrated circuit by using a verification apparatus comprising:
reading a list comprising a scenario and a parameter used for verification of the semiconductor integrated circuit;
generating, based on the list, transfer data used for the verification;
generating, based on the the list, a tag comprising information about the scenario; and
executing a test program based on the list using the transfer data.

11. The verification method for a semiconductor integrated circuit of claim 10, further comprising selectively incorporating the generated tag in the transfer data.

12. The verification method for a semiconductor integrated circuit of claim 11, further comprising specifying a position of the tag in the transfer data.

13. The verification method for a semiconductor integrated circuit of claim 12, wherein
the tag comprises at least one identifier indicative of a processor executing the scenario and an identifier indicative of the executed scenario.

14. The verification method for a semiconductor integrated circuit of claim 10, wherein the tag is converted into a fixed length.

15. The verification method for a semiconductor integrated circuit of claim 14, wherein the tag is converted into the fixed length using a hash function.

16. The verification method for a semiconductor integrated circuit of claim 10, further comprising:
verifying a multifunction semiconductor integrated circuit comprising a plurality of processors,
wherein the tag comprises at least one identifier indicative of one of the plurality of processors executing the scenario and also indicative of the scenario.

17. The verification method for a semiconductor integrated circuit of claim 10, further comprising generating an expected value of data generated by a test program based on the list, when the test program is executed using the transfer data.

18. A verification apparatus for a semiconductor integrated circuit, comprising:
a setting file storage module having stored therein a scenario list comprising one or more scenarios used for verification of the semiconductor integrated circuit and a parameter list comprising one or more parameters; and
a transfer data generation module configured to generate, based on a scenario selected from the scenario list and further based on a parameter selected from the parameter list, transfer data used for the verification and a tag comprising information of the scenario.

19. The verification apparatus for a semiconductor integrated circuit of claim 18, further comprising:
a test program assembly module configured to generate a test program on the basis of the scenarios and the lists; and
an information storage module configured to store the test program, the transfer data, and the tag.

20. The verification apparatus for a semiconductor integrated circuit of claim 19, further comprising an expected value generating module configured to generate an expected value of data generated by the test program.
